(19) United States
(12) Patent Application Publication
(10) Pub. No.: US 2024/0005053 A1
(43) Pub. Date: Jan. 4, 2024

(54) Magazine assembly deviation modeling method

(71) Applicant: SHANGHAI JIAO TONG UNIVERSITY, Shanghai (CN)

(72) Inventors: Zhimin LI, Shanghai (CN); Tao Liu, Shanghai (CN); Hehe Kang, Shanghai (CN); Wei Yuan, Shanghai (CN); Yuping Wu, Shanghai (CN)

(21) Appl. No.: 18/324,158

(22) Filed: May 26, 2023

Related U.S. Application Data
(63) Continuation of application No. PCT/CN2023/085948, filed on Apr. 3, 2023.

(30) Foreign Application Priority Data
Jul. 1, 2022 (CN) 202210766920.9

(51) Int. Cl. G06F 30/17; G06F 17/16

(52) U.S. Cl. CPC G06F 30/17; G06F 17/16; B64F 5/00

(57) ABSTRACT

The present invention is applicable to the field of aerospace component assembly deviation analysis, and provides a magazine assembly deviation modeling method to characterize the uncertainties in the local multi-parallel dimensional chains in the magazine bolted assembly structure, and to predict the spatial attitude deviation as well as the statistical distribution of the assembled magazine by tolerance analysis and randomness simulation of the assembly. The magazine assembly deviation modeling method described in the present invention can characterize the transfer and accumulation of complex three-dimensional tolerances in the multi-level magazine assembly process.

### TECHNICAL FIELD

The present invention belongs to the field of aerospace component assembly deviation analysis, and especially relates to a magazine assembly deviation modeling method.

### BACKGROUND TECHNOLOGY

The aero-engine is a highly complex and sophisticated thermal machinery, known as the “crown jewel” of the industry. The operational efficiency of an aero-engine depends on various factors such as structural design, material performance and manufacturing quality. Among them, the manufacturing quality and the geometric error of the components show a great correlation, the overall dynamic balance of the engine performance, operational safety have a greater impact. With the development of gas turbine engines, the efficiency, life and safety requirements of its components are becoming higher and higher, and the assembly quality has a great impact on the performance and structural safety of the engine.

As a key component in an aero-engine, the magazine processing and manufacturing process is extensive and involves manufacturing processes such as milling, pin pulling, polishing and heat treatment. Different kinds of manufacturing deviations are generated during the manufacturing and assembly of structural components. These deviations are mainly reflected in the fluctuation of the shape and position of the matching interface relative to the nominal value during the assembly process. The fluctuating values of the shape and position of each interface are transmitted and accumulated in the dimensional chain, resulting in deviations in the spatial position of the magazine after assembly, which in turn affects the service performance of the magazine, blade and even the whole engine.

At present, the tolerance design of the aero-engine magazine is mostly based on experience, which requires repeated trial and error to meet the requirements; and the tolerance analysis is based on the traditional one/two-dimensional dimensional chain, which cannot fully reflect the shape tolerance of the discontinuous interface of each assembly in three-dimensional space and the coupling relationship between the assembly features, thus leading to inaccurate analysis results, which cannot provide an accurate basis for the calibration of the assembly quality and the optimization of the tolerance distribution. In addition, the bolt connection between the magazine leads to the emergence of local parallel dimensional chains, resulting in the complicated transfer of magazine deviations.

Therefore, it is necessary to study the complex dimensional chain transfer of multi-stage magazine assembly with bolted connections. Based on the manufacturing and assembly accuracy of the magazine and the connection matching relationship, a prediction model of the magazine assembly deviation including series and parallel dimensional chains is established. It provides guidance for manufacturing optimization, tolerance allocation and performance control of the magazine.

### SUMMARY OF INVENTION

The purpose of the present invention is to provide a magazine assembly deviation modeling method to characterize the uncertainty in the local multi-parallel dimensional chain in the magazine bolted assembly structure, and to predict the spatial attitude deviation as well as the statistical distribution of the assembled magazine by tolerance analysis and randomness simulation of the assembly.

The present invention is realized as a method for modeling the assembly deviation of a magazine, comprising the following steps:
Step (1): preparing the tolerance requirements of each key geometric element required to model the dimensional chain of the magazine; such as the tolerance of the circumferential dimensions of the magazine, the tolerance values of the contour degree of each flange matching surface and the tolerance values of the position degree of the bolt holes, etc;
Step (2): establish the spin model of the deviation of each key geometric element of the magazine based on the small displacement spin theory;
Step (3): Consider that the bolt connection structure of the magazine is a typical local multi-parallel dimensional chain; couple the transfer of deviation in the bolt connection with the transfer of deviation of the flange surface to obtain the equivalent spin model; and
Step (4): considering that the flange surface is subject to both contour and parallelism tolerances, the limiting effect of parallelism tolerance on the angular deviation of the flange surface is introduced into the three-dimensional dimensional chain model of the magazine; the angular component in the spin model of parallelism tolerance is replaced by the angular component in the spin model of contour of the flange surface of the magazine;
Step (5): Considering the boundary conditions of each tolerance zone of the magazine, establishing a constraint relationship between the angular deviation and the flat deviation in the spin model;
Step (6): Substitute the constraint relations between the angular deviation and the flush deviation in the spin model into the three-dimensional dimensional chain model of the magazine to obtain the modified three-dimensional deviation transfer model of the magazine; the model takes into account the local parallel dimensional chain caused by the bolt connection, the angular deviation constraint caused by the flange surface flatness and the tolerance zone boundary constraint relations, etc.; the model can be used for the evaluation of the assembly quality of the magazine.

According to a further technical scheme, the step (3) is specifically divided into the following steps:
3.1 According to the actual assembly state, the effective rotational components of the bolt hole position degree rotation and flange face profile degree rotation are screened by intersection and calculation. Specifically, each bolt locating hole has a position degree tolerance requirement Tpo, which is cylindrical in shape and can be characterized by the translational components u2, v2 and rotational components α2, β2 along x and y directions. The magazine flange surface will have angular deviations α1, β1 along the x and y directions in the tolerance domain of the contour degree Ts. Since the value of β2 is usually larger than that of β1, interference in the assembly of the magazine bolt hole will occur when both reach the maximum value allowed by the respective tolerance domain. Therefore, the deviation surface of the magazine flange face will limit the bolt rotation in the position degree Tpo, and the allowed rotation angle of the bolt is limited by the angular deviation α1 and β1.

In addition, since the flange face profile does not limit the rotation along the z-axis direction, and the axisymmetric deviation of the two bolt locating hole positions will cause the flange face to produce a rotation deviation along the z-axis, when the position deviation of the two bolt locating holes shows the opposite direction, it will cause the connected flange face to produce an equivalent angular deviation γ′.

And combining the rotation components, and selecting α1, β1 and γ′ as angle deviation in an equivalent-rotation model of the flange surface of the effective casing to calculate a size chain.
3.2 Screening of the effective flat components of the bolt hole position rotation and flange face profile rotation by intersection and calculation according to the actual assembly state.

Specifically, u2 and v2 in the bolt positioning hole rotation model are translational deviations that directly affect the spatial position of the mating part. The matching flange surface will move the same position with u2 and v2 after bolting. The displacement deviation of the flange face in the x and y directions is equal to 0. Therefore, when the flange face is connected by bolts, the combined translational deviation of the flange face and the bolt locating hole in the u and v directions can be expressed by u2 and v2. The bolt hole and flange face rotation models are combined and u2 and v2 are selected as the effective translational deviations for the dimensional chain calculation.
3.3 Coupling the effective translational and rotational components in the flange face and bolt holes to form an equivalent rotational model of the magazine flange face connection, the expression is as follows:

T_{IFE1′}=[u₂ v₂ w₁ α₁ β₁ γ′]^{T}.

In a further technical solution, the flange surface is considered in step (4) to be subject to both contour and parallelism tolerances, and the limiting effect of parallelism tolerance on the angular deviation of the flange surface is introduced into the three-dimensional dimensional chain model of the magazine.

Specifically, the flange face of the magazine is subject to other tolerances in addition to the contouring requirements. For example, the top end face of the magazine has both a contour tolerance Ts and a parallelism tolerance Tpa, so it is necessary to consider the effect of the parallelism tolerance.

Specifically, the parallelism tolerance band Tpa is freely movable within a range having a width Ts, but cannot exceed the boundary determined by the profile tolerance band. The actual surface (red dotted line) can be translated and rotated up and down within the flatness tolerance band Tpa. That is, the profile tolerance and the parallelism tolerance together constitute a composite tolerance. In consideration of the limitation of the parallelism tolerance Tpa to the rotation angle of the flange face, the angular deviation in the rotation amount model is replaced by the angular deviation in the parallelism tolerance, and the expression is as follows:

$${T}_{IFE {1}^{′}} = {[ \begin{matrix}{u}_{2} & {v}_{2} & {w}_{1} & {α}^{′} & {β}^{′} & {γ}^{′}\end{matrix} ]}^{T} ,$$

$$\{ \begin{matrix}- \frac{Tpo}{2} \leq {u}_{2} \leq \frac{Tpo}{2} & - \frac{Tpa}{{D}_{a}} \leq {α}^{′} \leq \frac{Tpa}{{D}_{a}} \\ - \frac{Tpo}{2} \leq {v}_{2} \leq \frac{Tpo}{2} & - \frac{Tpa}{{D}_{a}} \leq {β}^{′} \leq \frac{Tpa}{{D}_{a}} \\ - \frac{T s}{2} \leq {w}_{1}^{r} \leq \frac{T s}{2} & - \frac{Tpo}{{D}_{a}^{′}} \leq {γ}^{′} \leq \frac{Tpo}{{D}_{a}^{′}}\end{matrix}$$

In a further technical solution, in step (5), a constraint relationship is established between the angular deviation and the flush deviation in the spin volume model, taking into account the boundary condition limitations of each tolerance zone of the magazine.

Specifically, when both w₁ and β′ are at their maximum in the tolerance band of Ts, the actual flange face will have a portion that exceeds the upper boundary of Ts. In order to keep the flange surface within the tolerance range, the value of β′ needs to be changed to 0 when w₁ is at a maximum. After considering the boundary constraints of the tolerance domain, the relationship between w₁ and α′, β′ in the spin T_{IFE1′} is as follows:

$$- \frac{T s}{2} \leq {w}_{1} + {α}^{′} \cdot y + {β}^{′} \cdot x \leq \frac{T s}{2}$$

$$- \frac{Tpa}{2} \leq {α}^{′} \cdot y + {β}^{′} \cdot x \leq \frac{Tpa}{2}$$

Similar to constraints in profile tolerance, there are also constraint relationships between u2, v2 and γ in T_{IFE1′}. The constraint relationship is as follows:

$$0 \leq {u}_{2}^{2} + {v}_{2}^{2} \leq {( \frac{Tpo}{2} )}^{2}$$

$$- \frac{Tpo}{2} \leq {v}_{2} + {γ}^{′} \cdot x \leq \frac{Tpo}{2} .$$

Compared with the prior art, the invention has the following beneficial effects:
(1) The magazine assembly deviation modeling method described in the present invention can characterize the transfer and accumulation of complex three-dimensional tolerances in the multi-stage magazine assembly process. Based on this method, the influence law and contribution of the tolerance or deviation size of any dimensional ring in the dimensional chain on the target deviation of the magazine can be obtained.
(2) The magazine assembly deviation modeling method described in the present invention considers the bolt connection assembly relationship, equates the complex local parallel dimensional chain, and solves the problem of difficult representation of the local dimensional chain due to the deviation transfer path between bolt matching surfaces.
(3) The magazine assembly deviation modeling method described in the present invention can be used not only for deviation prediction of target position in the initial state of the magazine after assembly, but also for deviation analysis of any position of the magazine. The method belongs to the explicit mathematical model, which has the characteristics of simplicity and high efficiency in solving.
(4) The magazine assembly deviation modeling method described in the present invention can obtain the fluctuation range of the target table deviation by the extreme value method, and can also calculate the statistical distribution of the target geometric elements by Monte Carlo simulation. For different types of deviation distributions that may exist in actual engineering, such as normal distribution, Pearson distribution, etc., they can also be solved by this dimensional chain model. The dimensional chain modeling method described in this invention has good engineering application capability.
(5) The present method is universal and can be used for dimensional chain analysis of any magazine containing bolted connections. In addition, the bolt-connected magazine mentioned in the present invention can be not only an aero-engine magazine, but also a ship turbine magazine, etc.

### DESCRIPTION OF ATTACHED DRAWINGS

FIG. 1 is a schematic structural view of a typical aircraft engine case;

FIG. 2 is a diagram of typical tolerance requirements for an intermediate casing;

FIG. 3 is a diagram of typical tolerance requirements for a high pressure case;

FIG. 4 is a chain diagram of the mounting relationship of the receiver;

FIG. 5 (a) is a curl characterization for a flat profile tolerance; FIG. 5 (b) is a curl characterization of the concentricity tolerance;

FIG. 6 (a), FIG. 6 (b), and FIG. 6 (c) are schematic diagrams illustrating the effective deviation of the bolt positioning hole connection;

FIG. 7 is a schematic view of the parallelism of the flange surfaces;

FIGS. 8 (a) and 8 (b) are schematic diagrams of the boundary of the profile degree;

FIGS. 9 (a) and 9 (b) are schematic views of the bolt hole position degree boundary;

FIG. 10 (a) is a statistical distribution graph of u in FR; FIG. 10 (b) is a statistical distribution plot of v in FR; FIG. 10 (c) is a statistical distribution of w in FR.

### SPECIFIC EMBODIMENTS

In order to make the object, technical solutions and advantages of the present invention more clearly understood, the present invention is described in further detail hereinafter in conjunction with the accompanying drawings and embodiments. It should be understood that the specific embodiments described herein are intended only to explain the present invention and are not intended to limit the present invention.

The specific implementation of the present invention is described in detail below in conjunction with specific embodiments.

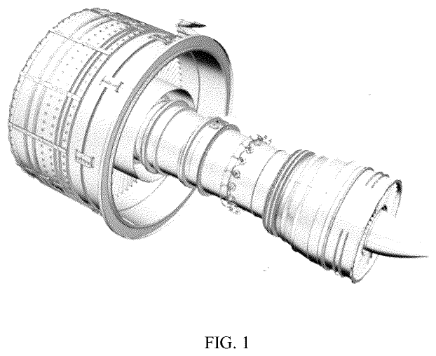

As shown in FIG. 1, the object depicted in this embodiment of the invention is a typical aero-engine magazine assembly. In this case, the magazine body is a cylindrical structure and the magazines are connected to each other by bolts.

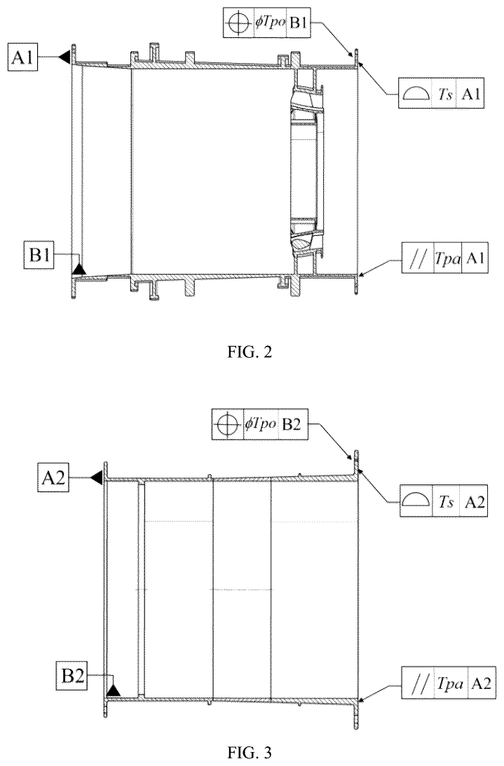

Based on the above described magazine, a magazine dimensional chain model considering bolted connections is established. The specific steps are as follows:
Step (1): Define the tolerance type and tolerance value of each key geometric element according to the matching relationship between the magazine and the tolerance requirements in the actual manufacturing process. For example, the tolerance of axial dimension of the magazine, the tolerance of flange surface profile, the tolerance of parallelism of flange surface, and the tolerance of position of bolt locating hole, as shown in FIG. 2 and FIG. 3. The bottom surface and the inner side of the magazine are defined as datum A and B. The top bolt locating hole has a position degree ϕTpo requirement with respect to datum B, while the datum and the bottom locating hole are considered to be in the nominal state. In addition, the top flange face of the magazine has a contour degree Ts requirement relative to reference A, accompanied by a parallelism tolerance Tpa. Da and Db are the outer diameters of the two magazine flange faces, respectively. Dₐ′ and D_{b}′ denote the distances between the two axisymmetric holes on the top flange faces of the two magazines, respectively. La and Lb are the axial lengths of the two magazines, respectively. The superscript Tu and subscript Td are the upper limit deviation and lower limit deviation of axial dimension. The specific values of the above geometric parameters are as follows:
La=962 mm, Lb=820 mm, Da=823 mm, Dₐ′=780 mm, Db=900 mm, D_{b}′=840 mm, Tu=0.03 mm, Td=0.03 mm, Wa=8.6 mm, Tpo=0.05 mm, Tpa=0.03 mm, Ts=0.05 mm, Wb=12 mm.
Step (2): According to the matching relationship between the magazine and the characteristics of related geometric elements, the deviation transfer path of the magazine can be divided into a series dimensional chain and a local parallel dimensional chain.

Specifically, LCS ‘0’ is the center point of the bottom surface of the intermediary magazine and serves as a reference point for evaluating the quality of the magazine assembly. lcs ‘1’, ‘4’ and LCS′2′, ‘3’, ‘5’ and ‘6’ indicate the center of the flange surface of the corresponding magazine. ‘6’ indicate the geometric centers of the bolt locating holes, respectively. In the magazine assembly, the flange face connection is used to limit the magazine's translation along the z-axis and rotation along the x/y-axis direction, and the geometric elements here are centered on the magazine axis, and the corresponding deviation transfer belongs to the tandem dimensional chain. And the bolt holes on the flange surface mainly restrain the magazine's translation along the x/y direction and rotation along the z direction. Relative to the center axis of the magazine, the deviation transfer caused by the bolt holes starts from both sides of the radial direction of the magazine, which belongs to the local parallel dimensional chain. For the convenience of analysis, two of the bolt holes in the evenly distributed bolt holes on the flange surface are defined here as locating holes, while the other bolt holes are only used as connecting holes.

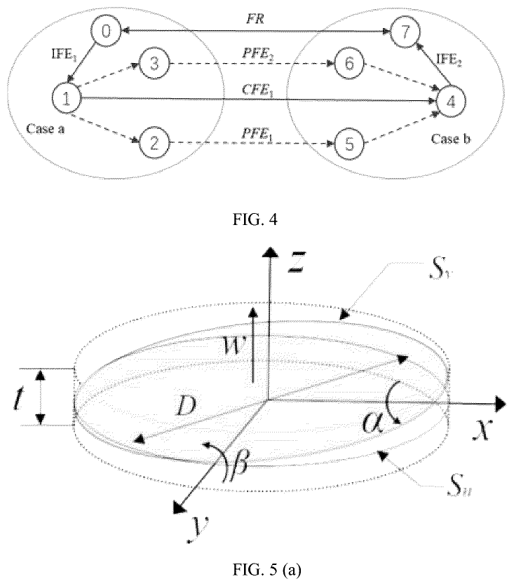

The assembly connection relationship of the magazine is shown in FIG. 4. There are five functional units FE, two internal functional units IFE, two parallel functional units PFE and one contact functional unit CFE, for characterizing one tandem dimensional chain and two local parallel dimensional chains. For a tandem dimensional chain, the dimensional ring is: IFE1-CFE1-CFE2-FR. where IFE1 is the contour degree deviation of the functional element corresponding to the coordinate system ‘1’ with respect to the coordinate system ‘0’. cfe 1 is defined as the deviation of the coordinate system CFE1 is defined as the dimensional deviation between coordinate system ‘1’ and coordinate system ‘4’. ‘s contour degree deviation. Functional dimensional requirement FR, is the target deviation for evaluating the quality of the magazine assembly. Here FR is defined as the relative spatial position relationship between the center points of both sides of the magazine, which is the relative position deviation between coordinate system ‘0’ and coordinate system ‘7’.

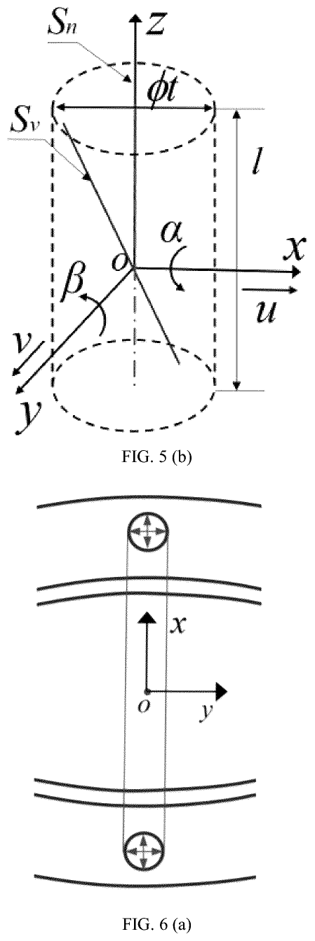

The tolerances of each key geometric element are characterized based on the small displacement spin volume theory. The spin volume characterization under common typical tolerance types is shown in FIG. 5(a) and FIG. 5(b), where Sv is the actual deviation surface, Sn is the nominal plane, α, β and γ are the rotation angle deviations about x, y and z axes, respectively, and u, v and w are the translational deviations about x, y and z axes, respectively. According to the tolerance requirements in step (1), the corresponding rotational volume model is established.

Specifically, the spin volume characterization of the tolerance of each functional unit in the magazine is as follows:

$${T}_{IFE 1} = {[ \begin{matrix}0 & 0 & {w}_{1} & {α}_{1} & {β}_{1} & 0\end{matrix} ]}^{T} , \{ \begin{matrix}- \frac{T s}{2} \leq {w}_{1} \leq \frac{T s}{2} \\ - \frac{T s}{{D}_{b}} \leq {α}_{1} \leq \frac{T s}{{D}_{b}} \\ - \frac{T s}{{D}_{b}} \leq {β}_{1} \leq \frac{T s}{{D}_{b}}\end{matrix} \qquad ( 1 )$$

$${T}_{CFE 1} = {[ \begin{matrix}0 & 0 & w & 0 & 0 & 0\end{matrix} ]}^{T} - T d \leq w \leq Tu \qquad ( 2 )$$

$${T}_{IFE 2} = {[ \begin{matrix}0 & 0 & w & α & β & 0\end{matrix} ]}^{T} , \{ \begin{matrix}- \frac{T s}{2} \leq w \leq \frac{T s}{2} \\ - \frac{T s}{{D}_{b}} \leq α \leq \frac{T s}{{D}_{b}} \\ - \frac{T s}{{D}_{b}} \leq β \leq \frac{T s}{{D}_{b}}\end{matrix} \qquad ( 3 )$$

Considering that the axial dimensional tolerance of the high-pressure magazine can have a significant effect on the FR component in the z-direction, the spin w in TIFE2 is replaced here with the following expression:

$$- \frac{T s}{2} - T d \leq w \leq \frac{T s}{2} + Tu \qquad ( 4 )$$

Step (3): The dashed connections shown in FIG. 4 are the local parallel dimensional chains PFE1 and PFE2 due to the bolts. PFE1 and PFE2 are the deviations of the positioning holes corresponding to coordinate systems ‘2’ and ‘3’, respectively, with respect to coordinate systems PFE1 and PFE2 are the deviations of the position degrees of the locating holes corresponding to coordinate systems ‘5’ and ‘6’, respectively. The transfer of deviations in the bolted connection and the transfer of flange face deviations are coupled to obtain the equivalent spin volume model. This is further divided into the following sub-steps:

Based on the actual assembly state, the effective rotational components of the bolt hole position degree rotation and flange face profile degree rotation are filtered by intersection and calculation.

Specifically, each bolt locating hole has a positional tolerance requirement Tpo, the tolerance domain is cylindrical in shape and can be characterized by the translational components u, v and rotational components α, β along the x and y directions, with the following expression for the rotational components:

T_{PFE}=[u₂ v₂ 0 α₂ β2 0]^{T} (5)

Obviously, due to the leverage effect of angular deviation, the position degree of the bolt locating hole affects the coaxiality of both sides of the magazine, which in turn leads to the change of the target deviation FR. For example, the rotational component β along the y-axis in the position degree tolerance domain leads to a position deviation w along the z-direction on the top surface of the magazine.

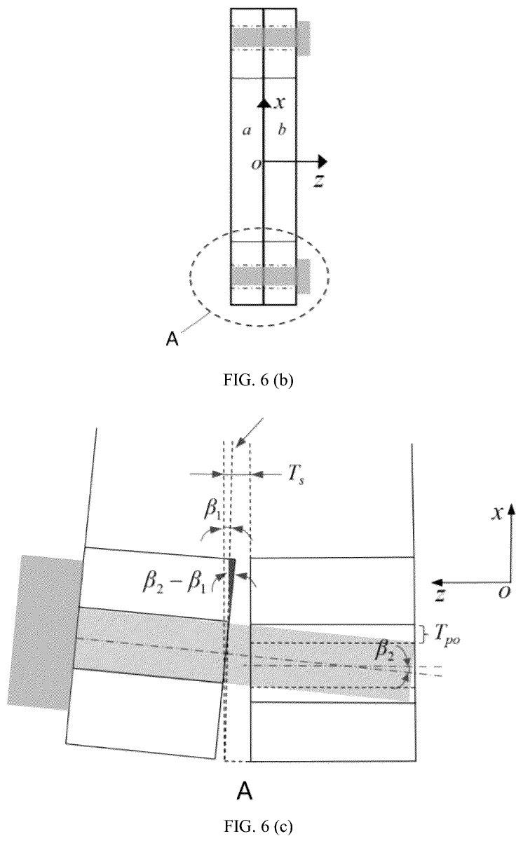

It should be noted that the interference phenomenon will occur between the deviation of the bolt locating hole position degree and the deviation of the contour degree of the fixed end face of the magazine. As shown in FIG. 6(a), FIG. 6(b) and FIG. 6(c), the flange face of the magazine will have an angular deviation β1 along the y direction in the tolerance domain of the contour degree Ts. β2 is the angular deviation of the bolt locating hole along the y direction in the tolerance domain of the position degree Tpo. Since the value of β2 is usually larger than the value of β1, the assembly of the magazine bolt hole will interfere when both of them reach the maximum value allowed in their respective tolerance domains, but in reality this interference assembly state is not allowed to exist. The deviation surface of the magazine flange face will limit the rotation of the bolt in the position degree Tpo, and the allowed rotation angle of the bolt is limited by the angular deviation β1.

In order to avoid such interference in the connection, the angular deviations α2 and β2 of the bolt holes in the parallel dimensional chain need to be less than or equal to the angular deviations α1 and β1 of the flange face profile.

In addition, since the flange face profile does not limit the rotation along the z-axis direction, and the axisymmetric two bolt locating hole position deviation will cause the flange face to produce the rotation deviation along the z-axis, as shown in FIG. 6(a), FIG. 6(b), and FIG. 6(c). When the position deviation of the two bolt locating holes shows the opposite direction, it will cause the connected flange face to produce the equivalent angular deviation γ′.

Therefore, the individual rotation components in TPFE and TIFE1 are combined for the operation, and α1, β1 and γ′ are selected as the effective angular deviations for the dimensional chain calculation.

Based on the actual assembly state, the effective flat components of the bolt hole position degree rotation and flange face profile degree rotation are screened by intersection and calculation.

Specifically, u2 and v2 in the bolt location hole rotation model TPFE are translational deviations that directly affect the spatial position of the mating part. The matching flange surface will move the same position with u2 and v2 after bolting. The displacement deviation of the flange face in the x and y directions is equal to 0. Therefore, when the flange face is connected by bolts, the combined translational deviation of the flange face and the bolt locating hole in the u and v directions can be expressed by u2 and v2. The individual translational components in TPFE and TIFE1 are combined and u2 and v2 are selected as the effective translational deviations for the dimensional chain calculation.
(3) Coupling the effective translational and rotational components in the flange face and bolt holes to form an equivalent rotational model of the magazine flange face connection, the expression is as follows:

T_{IFE1′}=[u₂ v₂ w₁ α₁ β₁ γ′]^{T} (6)
(4) The equivalent spin volume model in (3) is coupled to the magazine tandem dimensional chain, and the three-dimensional dimensional chain model of the magazine is obtained based on Jacobi-spin volume theory. The general expression of the Jacobi-spinor model is as follows:

$${J}_{FEi} = [ \begin{matrix}{R}_{0}^{i} {R}_{Pti} & {W}_{i}^{n} ( {R}_{0}^{i} {R}_{Pti} ) \\ 0 & {R}_{0}^{i} {R}_{Pti}\end{matrix} ] \qquad ( 7 )$$

Specifically, Rⁱ₀ is a 3×3 direction matrix, which is the direction matrix between the ith FE with respect to the global coordinate system “0”. It characterizes the directional transformation of the coordinate system in which the ith element is located. Specifically, Rⁱ₀ is defined as follows:

Rⁱ₀=[C₁₁ C₂₁ C₃₁] (8)

Specifically, the elements C11, C21 and C31 are unit vectors representing the projection vectors of the ith element sitting in the local coordinate system tri-coordinate with respect to the global coordinate system “0” tri-coordinate direction, which correspond to the x, y and z axis directions, respectively.

$${W}_{i}^{n} = [ \begin{matrix}0 & d {z}_{i}^{n} & - d {y}_{i}^{n} \\ - d {z}_{i}^{n} & 0 & d {x}_{i}^{n} \\ d {y}_{i}^{n} & - d {x}_{i}^{n} & 0\end{matrix} ] \qquad ( 9 )$$

Specifically, Wᵢⁿ is the antisymmetric matrix for representing the 3D distance vector between the ith element and the nth element (i.e., the target element). dxᵢⁿ, dyᵢⁿ and dzᵢⁿ can be calculated by the following equation:

dxᵢⁿ=dxₙ−dxᵢ

dyᵢⁿ=dyₙ−dyᵢ

dzᵢⁿ=dzₙ−dzᵢ (10)

Specifically, dxi, dyi and dzi are the distances of the coordinate system where the ith element is located with respect to the global coordinate system in the x, y and z directions. The product between the direction matrix and the distance matrix, Wᵢⁿ. Rⁱ₀, is used to characterize the leverage effect of the deviation in the transfer process, while R_{Pti} is the projection matrix, which represents the projection matrix between the direction of the deviation analysis and the tolerance band.

Bringing equations (2), (3) and (6) into equation (7), the Jacobi-spin volume deviation model of the magazine assembly containing bolted connections is obtained, and the specific expression is as follows:

$${[ \begin{matrix}u \\ v \\ w \\ α \\ β \\ γ\end{matrix} ]}_{FR} = [ \begin{matrix}{J}_{IFE {1}^{′}} & {J}_{CFE 1} & {J}_{IFE 2}\end{matrix} ] \cdot {[ {{{[ \begin{matrix}{u}_{2} \\ {v}_{2} \\ {w}_{1} \\ {α}_{1} \\ {β}_{1} \\ {γ}^{′}\end{matrix} ]}_{IFE {1}^{′}} [ \begin{matrix}0 \\ 0 \\ w \\ 0 \\ 0 \\ 0\end{matrix} ]}_{CFE 1} [ \begin{matrix}0 \\ 0 \\ w \\ α \\ β \\ 0\end{matrix} ]}_{IFE 2} ]}^{T} \qquad ( 11 )$$

$${J}_{IFE {1}^{′}} = [ \begin{matrix}1 & 0 & 0 & 0 & {L}_{b} & 0 \\ 0 & 1 & 0 & - {L}_{b} & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] , \\ {J}_{CFE 1} = [ \begin{matrix}1 & 0 & 0 & 0 & {L}_{b} & 0 \\ 0 & 1 & 0 & - {L}_{b} & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] , {J}_{IFE 2} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] \qquad ( 12 )$$

Step (4): Considering that the flange face is subject to both contour and parallelism tolerance requirements, the limiting effect of parallelism tolerance on the angular deviation of the flange face is introduced into the 3D dimensional chain model of the magazine.

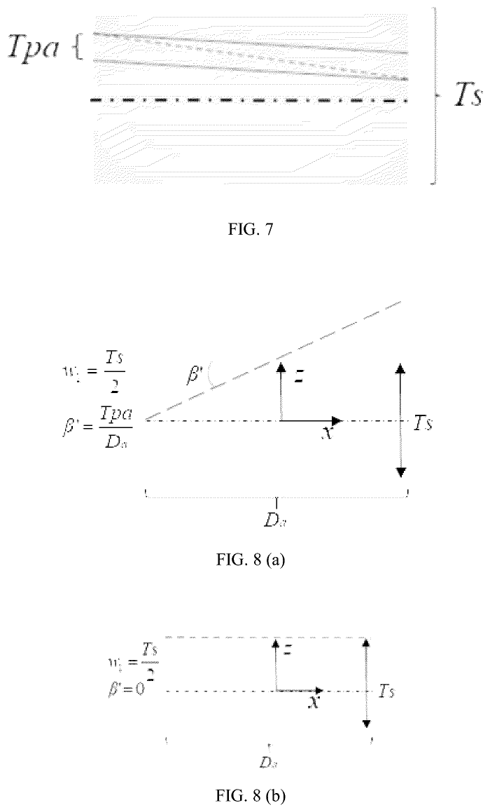

Specifically, as in the case of IFE1 and IFE2 of the connection chain in FIG. 4, the tolerance domains they correspond to are characterized only by contour degree. However, the flange face of the magazine is subject to other tolerances in addition to the contour degree requirement. As shown in FIGS. 2 and 3, the top end face of the magazine has both a contour tolerance Ts and a parallelism tolerance Tpa, so it is necessary to consider the influence brought by the parallelism tolerance. FIG. 7 shows the contour tolerance zone and parallelism tolerance zone. As can be seen, the parallelism tolerance band Tpa (red line) is free to move within a width of Ts, but not beyond the boundary defined by the contour degree tolerance band. The actual surface (red dashed line), on the other hand, can be translated and rotated up and down in the flatness tolerance zone Tpa. In other words, the contour degree tolerance and the parallelism tolerance together form a compound tolerance. Considering the restriction of the flange surface rotation angle by the parallelism tolerance Tpa, it is necessary here to modify the model of the flange surface rotation amount to meet the actual deviation constraint. The expression of the corresponding rotation is as follows:

$${T}_{IFE {1}^{′}} = {[ \begin{matrix}{u}_{2} & {v}_{2} & {w}_{1} & {α}^{′} & {β}^{′} & {γ}^{′}\end{matrix} ]}^{T} , \\ \{ \begin{matrix}- \frac{Tpo}{2} \leq {u}_{2} \leq \frac{Tpo}{2} & - \frac{Tpa}{{D}_{a}} \leq {α}^{′} \leq \frac{Tpa}{{D}_{a}} \\ - \frac{Tpo}{2} \leq {v}_{2} \leq \frac{Tpo}{2} & - \frac{Tpa}{{D}_{a}} \leq {β}^{′} \leq \frac{Tpa}{{D}_{a}} \\ - \frac{T s}{2} \leq {w}_{1}^{r} \leq \frac{T s}{2} & - \frac{Tpo}{{D}_{a}^{′}} \leq {γ}^{′} \leq \frac{Tpo}{{D}_{a}^{′}}\end{matrix} \qquad ( 13 )$$

$${T}_{IFE 2} = {[ \begin{matrix}0 & 0 & w & {α}^{′} & {β}^{′} & 0\end{matrix} ]}^{T} , \{ \begin{matrix}- \frac{T s}{2} - T d \leq w \leq \frac{T s}{2} + T u \\ - \frac{Tpa}{{D}_{b}} \leq {α}^{′} \leq \frac{Tpa}{{D}_{b}} \\ - \frac{Tpa}{{D}_{b}} \leq {β}^{′} \leq \frac{Tpa}{{D}_{b}}\end{matrix} \qquad ( 14 )$$

The above equations (13) and (14) are brought into equation (11) to obtain the deviation model of the bolted magazine with parallelism.
Step (5): Considering the boundary condition restriction of each tolerance zone of the magazine, a constraint relationship is established between the angular deviation and the flush deviation in the rotational volume model.

Specifically, the tolerance band for the flange face profile degree Ts as shown in FIG. 8(a) and FIG. 8(b). When both w₁ and β′ take the maximum value, the actual flange face indicated by the red dashed line will be partially outside the upper boundary of Ts. In order to keep the flange face within the tolerance zone, it is necessary to change the value of β′ to 0 at the maximum value of w₁. This indicates that there is a constraint relationship between the translational and rotational components to satisfy the boundary of the tolerance domain Ts.

After considering the boundary constraints of the tolerance domain, the relationship between w₁ and α′ and β′ in the spin volume T_{IFE1′} is as follows:

$$- \frac{T s}{2} \leq {w}_{1} + {α}^{′} \cdot y + {β}^{′} \cdot x \leq \frac{T s}{2} - \frac{Tpa}{2} \leq {α}^{′} \cdot y + {β}^{′} \cdot x \leq \frac{Tpa}{2} \qquad ( 15 )$$

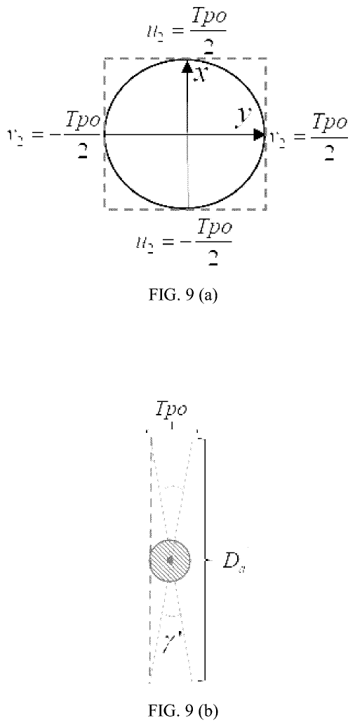

Similar to the constraint in the contour tolerance, there is a constraint relationship between u2, v2 and γ in T_{IFE1′}. As shown in FIG. 9(a) and FIG. 9(b), when u2 and v2 reach the maximum value, the center point position will be out of the circular tolerance domain. Only a value of 0 for γ′ when v2 is at its maximum value can avoid exceeding the boundary. Correspondingly, the constraint relationship between u2, v2 and γ′ is as follows:

$$0 \leq {u}_{2}^{2} + {v}_{2}^{2} \leq {( \frac{Tpo}{2} )}^{2} - \frac{Tpo}{2} \leq {v}_{2} + {γ}^{′} \cdot x \leq \frac{Tpo}{2} \qquad ( 16 )$$

Step (6): The constraint relationship between angular deviation and parallel deviation in step (5) is substituted into the three-dimensional dimensional chain model of the magazine, and the modified three-dimensional deviation transfer model of the magazine is obtained, and the specific expression is shown in equation (17). The model takes into account the local parallel dimensional chain caused by the bolted connection, the angular deviation constraint caused by the flange surface flatness, and the tolerance zone boundary constraint relationship.

$$( 17 ) \\ {[ \begin{matrix}u \\ v \\ w \\ α \\ β \\ γ\end{matrix} ]}_{FR} = [ \begin{matrix}{J}_{IFE {1}^{′}} & {J}_{CFE 1} & {J}_{IFE 2}\end{matrix} ] \cdot [ \begin{matrix}{[ [ \begin{matrix}{u}_{2} \\ {v}_{2} \\ {w}_{1} \\ {α}^{′} \\ {β}^{′} \\ {γ}^{′}\end{matrix} ] S . t \{ \begin{matrix}- \frac{T s}{2} \leq {w}_{1} + {α}^{′} \cdot y + {β}^{′} \cdot x \leq \frac{T s}{2} \\ - \frac{Tpa}{2} \leq {α}^{′} \cdot y + {β}^{′} \cdot x \leq \frac{Tpa}{2} \\ 0 \leq {u}_{2}^{2} + {v}_{2}^{2} \leq {( \frac{Tpo}{2} )}^{2} \\ - \frac{Tpo}{2} \leq {v}_{2}^{r} + {γ}^{′} \cdot x \leq \frac{Tpo}{2}\end{matrix} \} ]}_{IFE {1}^{′}} \\ {[ \begin{matrix}0 \\ 0 \\ w \\ 0 \\ 0 \\ 0\end{matrix} ]}_{CFE 1} \\ {[ [ \begin{matrix}0 \\ 0 \\ w \\ {α}^{′} \\ {β}^{′} \\ 0\end{matrix} ] S . t \{ \begin{matrix}- \frac{T s}{2} - Td \leq w + {α}^{′} \cdot y + {β}^{′} \cdot x \leq \frac{T s}{2} + Tu \\ - \frac{Tpa}{2} \leq {α}^{′} \cdot y + {β}^{′} \cdot x \leq \frac{Tpa}{2}\end{matrix} \} ]}_{IFE 2}\end{matrix} ]$$

Considering that most of the deviations in actual engineering show normal distribution, this example generates 5000 sample points randomly according to the normal distribution function, from which the deviations that meet the tolerance boundary constraints are selected, and the statistical distribution of the target deviation FR of the assembly is calculated by the established magazine assembly deviation model.

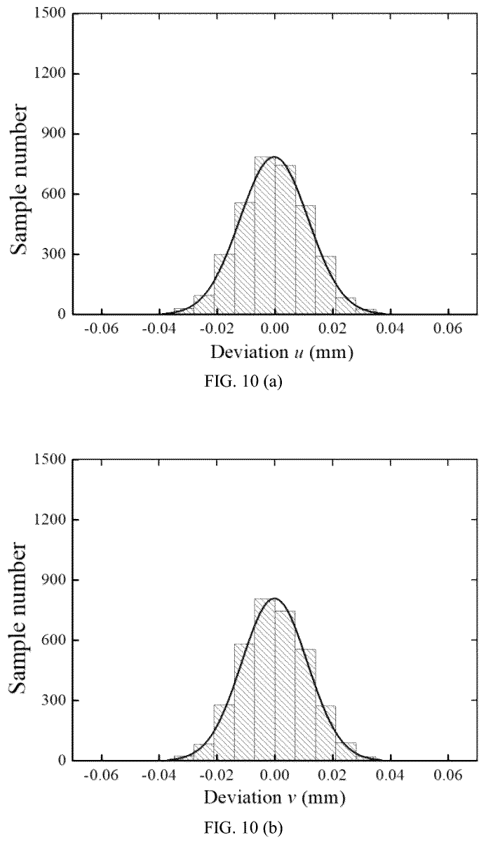

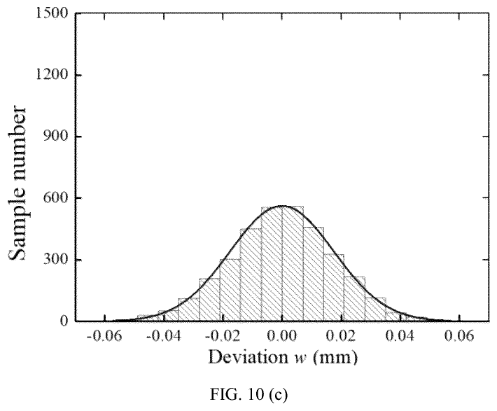

The statistical distributions of the distance deviation FR between the center points on both sides of the magazine assembly along the x, y and z direction components are shown in FIG. 10(a), FIG. 10(b) and FIG. 10(c). Specifically, the standard deviations of the statistical distributions of deviations u, v and w are: 0.0119 mm, 0.0115 mm and 0.0177 mm, respectively.

By means of the magazine dimensional chain modeling method described in this example and the established dimensional chain model, the local parallel dimensional chain of the bolted connection is coupled with the tandem dimensional chain of the magazine, and on this basis the influence of the composite tolerance of the flange face due to parallelism and the tolerance zone boundary constraints are considered. The model enables to calculate the statistical distribution of the position deviation of the magazine assembly as well as the target deviation.

The above embodiments are only a part of the present invention. The tolerance values and the geometry of the magazine structure described in the embodiment are only an example, and the results of the target deviation vary accordingly for different tolerance values and dimensions. The analysis of deviations can be performed by the dimensional chain modeling method described in the embodiment according to the actual engineering structure and requirements. The above described is only a specific implementation of the present invention, and any variation or equivalent replacement, improvement, etc. that can be readily thought of within the spirit and principles of the present invention shall be included in the scope of protection of the present invention for a person skilled in the art. Therefore, the scope of protection of the present invention shall be subject to the scope of protection of the said claims. It is not intended to limit the present invention.

The above is only a better embodiment of the present invention, and is not intended to limit the invention. Any modifications, equivalent replacements and improvements made within the spirit and principles of the present invention shall be included in the scope of protection of the present invention.

In addition, it should be understood that, although this specification is described in accordance with the embodiment, but not each embodiment contains only a separate technical solution, the specification of this narrative only for clarity, the skilled person in the field should take the specification as a whole, the technical solutions in each embodiment can also be properly combined to form other embodiments can be understood by the skilled person in the field.

What is claimed is:

1. A method for modeling the assembly deviation of a magazine, characterized in that it comprises the following steps:
Step (1): preparing the tolerance requirements of each key geometric element required to model the dimensional chain of the magazine, such as the tolerance of the circumferential dimension of the magazine, the tolerance value of the contour degree of each flange matching surface, and the tolerance value of the position degree of the bolt hole;
Step (2): establishing the spin volume model of the deviation of each key geometric element of the magazine based on the small displacement spin volume theory;
Step (3): coupling the transfer of deviations in the bolt connection and the transfer of flange surface deviations to obtain the equivalent spin model;
Step (4): introduce the limiting effect of parallelism tolerance on the angular deviation of the flange face into the three-dimensional dimensional chain model of the magazine; replace the angular component in the spin model of parallelism tolerance with the angular component in the spin model of the flange face profile;
Step (5): establishing a constraint relationship between the angular deviation and the flush deviation in the spin model;
Step (6): Substitute the constraint relationship between the angular deviation and the flat deviation in the spin model into the three-dimensional dimensional chain model of the magazine to obtain the modified three-dimensional deviation transfer model of the magazine.

2. The method for modeling the assembly deviation of the magazine according to claim 1, characterized in that said step (3) is specifically subdivided into the following steps:
3.1 screening the effective rotational components of the bolt hole position degree rotation and the flange face profile degree rotation by intersection and concatenation operations according to the actual assembly state;
3.2 Screening the bolt hole position rotation and the flange face profile rotation by intersection and concatenation operations according to the actual assembly state;
3.3 Coupling the effective translational and rotational components in the flange face and bolt hole to form an equivalent rotational model of the flange face connection of the magazine;
3.4 Coupling the equivalent spin model in step 3.3 into the magazine tandem dimensional chain, and obtaining the three-dimensional dimensional chain model of the magazine based on Jacobi-spin theory.

3. The magazine assembly deviation modeling method according to claim 2, characterized in that step (3) couples the effective translational and rotational components in the flange face and bolt holes to form an equivalent rotational model of the magazine flange face connection with the following expression:
T_{IFE1′}=[u₂ v₂ w₁ α₁ β₁ γ′]^{T}.

4. The method for modeling the assembly deviation of the magazine according to claim 1, characterized in that the angular deviation in the spin volume model in step (4) T_{IFE1′} is replaced by the angular deviation in the parallelism tolerance with the following expression:
$${T}_{IFE {1}^{′}} = {[ \begin{matrix}{u}_{2} & {v}_{2} & {w}_{1} & {α}^{′} & {β}^{′} & {γ}^{′}\end{matrix} ]}^{T} , \\ \{ \begin{matrix}- \frac{Tpo}{2} \leq {u}_{2} \leq \frac{Tpo}{2} & - \frac{Tpa}{{D}_{a}} \leq {α}^{′} \leq \frac{Tpa}{{D}_{a}} \\ - \frac{Tpo}{2} \leq {v}_{2} \leq \frac{Tpo}{2} & - \frac{Tpa}{{D}_{a}} \leq {β}^{′} \leq \frac{Tpa}{{D}_{a}} \\ - \frac{T s}{2} \leq {w}_{1}^{r} \leq \frac{T s}{2} & - \frac{Tpo}{{D}_{a}^{′}} \leq {γ}^{′} \leq \frac{Tpo}{{D}_{a}^{′}}\end{matrix} .$$

5. The magazine assembly deviation modeling method according to claim 1, characterized in that the relationship between w₁ and α′, β′ in the spin volume T_{IFE1′} in step (5) is as follows:
$$- \frac{T s}{2} \leq {w}_{1} + {α}^{′} \cdot y + {β}^{′} \cdot x \leq \frac{T s}{2}$$
$$- \frac{Tpa}{2} \leq {α}^{′} \cdot y + {β}^{′} \cdot x \leq \frac{Tpa}{2} .$$
